(19) United States
(12) Patent Application Publication
(10) Pub. No.: US 2026/0208377 A1
(43) Pub. Date: Jul. 23, 2026

(54) TRIMMER AND TRIMMING METHOD

(71) Applicant: Duplo Corporation, Sagamihara-shi (JP)

(72) Inventor: Wataru Minegishi, Sagamihara-shi (JP)

(73) Assignee: Duplo Corporation, Sagamihara-shi (JP)

(21) Appl. No.: 19/410,047

(22) Filed: Dec. 5, 2025

(30) Foreign Application Priority Data
Jan. 23, 2025 (JP) 2025-009996

(51) Int. Cl. B26D 1/09; B26D 1/00

(52) U.S. Cl. CPC B26D 1/095; B26D 1/0006; B26D 2001/0033

(57) ABSTRACT

A trimmer trims a booklet by a fixed blade and a movable blade. The movable blade includes a main blade that extends in a booklet conveying direction, and an accessory blade for making a cut in a spine of the booklet, the accessory blade being disposed at one end side of the main blade and integrally moving with the main blade. A cutting edge of the accessory blade is spaced apart from a cutting edge of the main blade, in a moving direction of the movable blade moving with respect to the fixed blade.

### BACKGROUND OF THE INVENTION

### 1. Field of the Invention

The present disclosure relates to a trimmer and a trimming method.

### 2. Description of the Related Art

U.S. Pat. No. 3,074,304 discloses a trimmer for trimming booklets perpendicularly to a spine of a booklet by a fixed blade and a movable blade. The movable blade of this trimmer has an accessory blade that trims a spine side of a booklet prior to trimming by a main blade, in order to avoid shearing defects from occurring.

The trimmer according to U.S. Pat. No. 3,074,304 is capable of suppressing occurrence of shearing defects as compared to trimmers in which the movable blade does not have the accessory blade. However, through diligent study, the present inventor has found that the trimmer according to U.S. Pat. No. 3,074,304 has room for improvement with respect to suppressing occurrence of shearing defects.

### SUMMARY OF THE INVENTION

The present disclosure has been made in light of the foregoing circumstances, and an exemplary object of an aspect thereof is to provide technology that is capable of suppressing occurrence of shearing defects during trimming of booklets.

In order to solve the above problem, according to an aspect of the present invention, in a trimmer for trimming a booklet by a fixed blade and a movable blade, the movable blade includes a main blade that extends in a booklet conveying direction, and an accessory blade for making a cut in a spine of the booklet. The accessory blade is disposed at one end side of the main blade and integrally moves with the main blade. A cutting edge of the accessory blade is spaced apart from a cutting edge of the main blade, in a moving direction of the movable blade moving with respect to the fixed blade.

Another aspect of the present invention is a trimming method. This method includes starting descent toward a booklet by a movable blade that includes a main blade extending in a booklet conveying direction, and an accessory blade for making a cut in a spine of the booklet, the accessory blade being disposed at one end side of the main blade and integrally moving with the main blade, starting to make a cut in a portion of the spine of the booklet by the accessory blade, and trimming of the booklet by the main blade coming into contact with the booklet after an interval of time following the accessory blade starting the cutting, and further sliding against the fixed blade.

### BRIEF DESCRIPTION OF THE DRAWINGS

FIG. 1 is a perspective view of a bookbinding system that is equipped with a trimmer according to an embodiment;

FIG. 2 is a side view of a top-bottom edge trimmer in FIG. 1;

FIG. 3 is a perspective view of the top-bottom edge trimmer in FIG. 1;

FIG. 4 is a side view of a trimming unit of the top-bottom edge trimmer in FIG. 1;

FIG. 5 is an enlarged view of a portion surrounded by dashed lines in FIG. 4;

FIG. 6 is a view of the trimming unit of the top-bottom edge trimmer in FIG. 1 as viewed from an upstream side in a booklet conveyance direction; and

FIGS. 7A to 7H are diagrams for describing a way in which trimming is performed by the top-bottom edge trimmer.

### DESCRIPTION OF THE PREFERRED EMBODIMENTS

The present disclosure will be described below by way of a preferred embodiment, with reference to the drawings. The embodiment does not limit the disclosure but rather is exemplary, and not all features and combinations thereof described in the embodiment are necessarily essential to the disclosure. Components, members, and processing that are the same or equivalent in the drawings are denoted by the same symbols, and repetitive description will be omitted as appropriate.

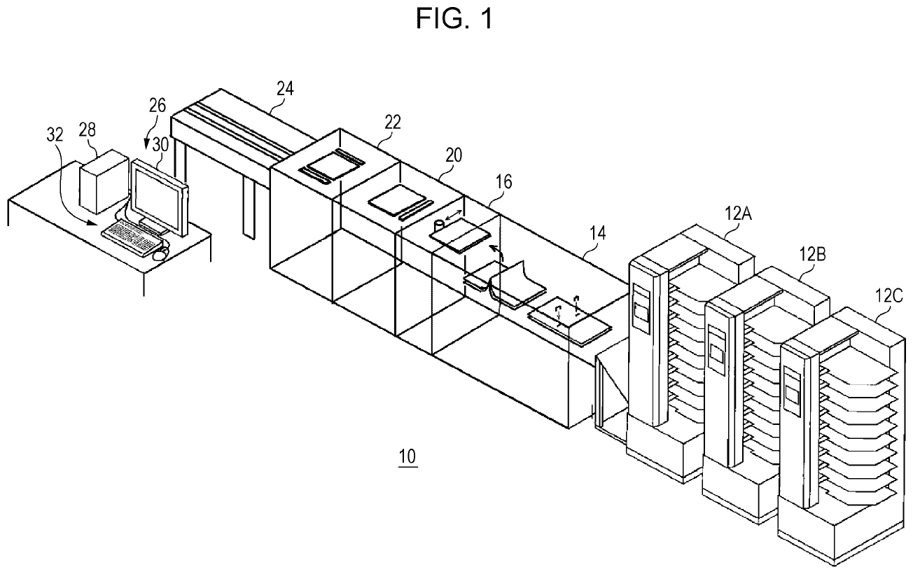

FIG. 1 is a perspective view of a bookbinding system 10 that is equipped with a top-bottom edge trimmer 22 according to the embodiment. The bookbinding system 10 subjects sheets, on which text and images have been printed, to post-processing such as collating, folding, binding, trimming, and so forth. The bookbinding system 10 includes collating devices 12A, 12B, and 12C (hereinafter referred to as “collating device 12” when not differentiating therebetween), a center stitching and folding device 14, a square spine forming device 16, a fore edge trimmer 20, the top bottom edge trimmer 22, a belt stacker 24, and a control device 26. Note that the number of the collating devices 12 is not limited in particular.

The three collating devices 12 each have a plurality of sheet feeding units. The three collating devices 12 each stack sheets while feeding sheets from each of the plurality of sheet feeding units. The three collating devices 12 are disposed serially, and are capable of stacking a sheet stack created by a collating device 12 disposed to an upstream side upon a sheet stack created by a collating device 12 disposed to a downstream side.

The center stitching and folding device 14 accumulates sheet stacks conveyed in from the collating devices 12 until one set of sheet stacks making up one booklet to be bound is accumulated, and binds two positions in the middle portion thereof in a conveying direction by wire. The center stitching and folding device 14 further folds the one set of the sheet stacks that has been accumulated into two at the bound portion, thereby creating a center stitched booklet (hereinafter, referred to simply as “booklet”). The center stitching and folding device 14 conveys the booklet, which is created, out to the square spine forming device 16.

The square spine forming device 16 is a device for shaping the spine of the booklet into a square form. The greater the number of sheets that are included in the booklet is, the larger the curvature of the arc form that is formed will be for the sheet on the outermost part of the spine. Deforming this into a square shape yields effects of improved visual quality, suppression of opening at the fold, and so forth. The square spine forming device 16 conveys the booklet with the formed spine out to the fore edge trimmer 20. The square spine forming device 16 can allow the booklet to pass through as it is, without shaping the spine of the booklet. That is to say, the square spine forming device 16 conveys the booklet conveyed in from the center stitching and folding device 14 to the fore edge trimmer 20 as it is with the spine unshaped, or with the spine shaped into a square form. Booklets of which the spine is shaped into a square shape by the square spine forming device 16 are referred to hereinafter as “square back booklets”, while booklets that are passed through without shaping the spine are referred to as “round back booklets”.

The fore edge trimmer 20 trims the fore edge of the booklet conveyed in from the square spine forming device 16, and performs conveying thereof out to the top-bottom edge trimmer 22. The top-bottom edge trimmer 22 trims top and bottom of the booklet conveyed in from the fore edge trimmer 20, and performs conveying thereof to the belt stacker 24. The belt stacker 24 sequentially accumulates booklets conveyed from the top-bottom edge trimmer 22.

The collating device 12, the center stitching and folding device 14, the square spine forming device 16, the fore edge trimmer 20, and the belt stacker 24 may be configured using known technology or technology that will be usable in the future.

The control device 26 includes an information processing device 28, a display 30, and an input device 32. An example of the information processing device 28 is a personal computer (PC) that includes a central processing unit (CPU) of executing various types of computation processing, read-only memory (ROM) that stores various types of control programs, and random access memory (RAM) that is used for storing data and as a work area for executing programs. The input device 32 includes a keyboard, a mouse, or the like. Note that a touchscreen display may be employed as the display 30. In this case, the display 30 also functions as an input device. The control device 26 centrally controls the bookbinding system 10.

This so far is an overall configuration of the bookbinding system 10. Next, the configuration of the top-bottom edge trimmer 22 will be described in detail.

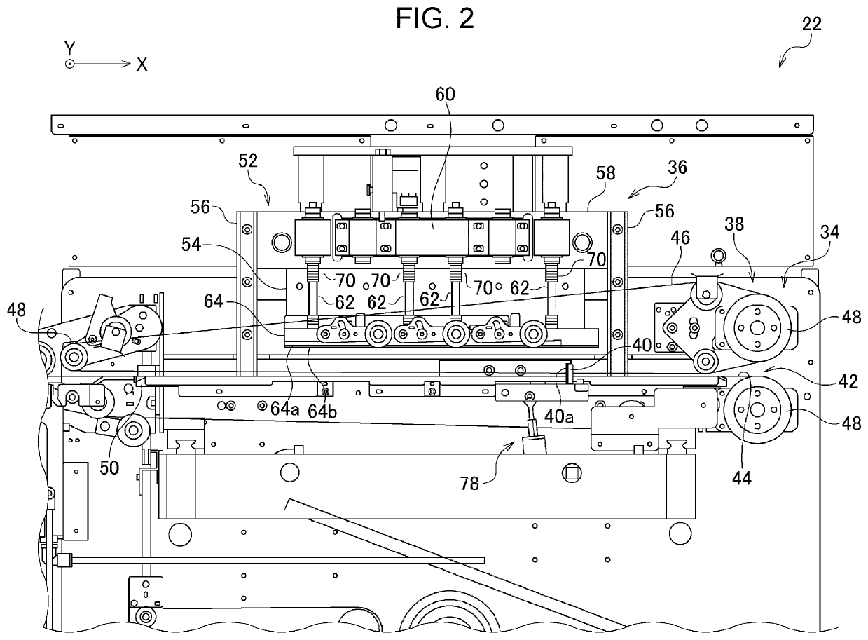

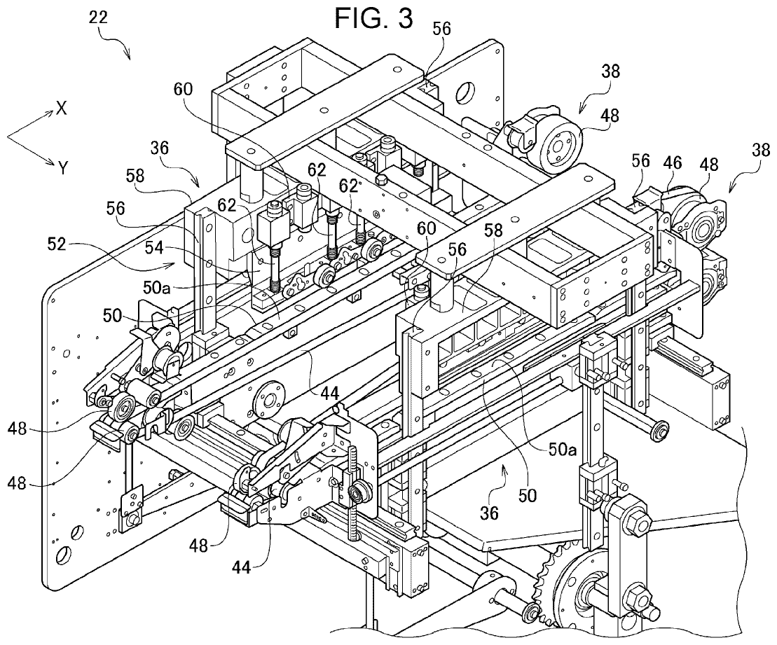

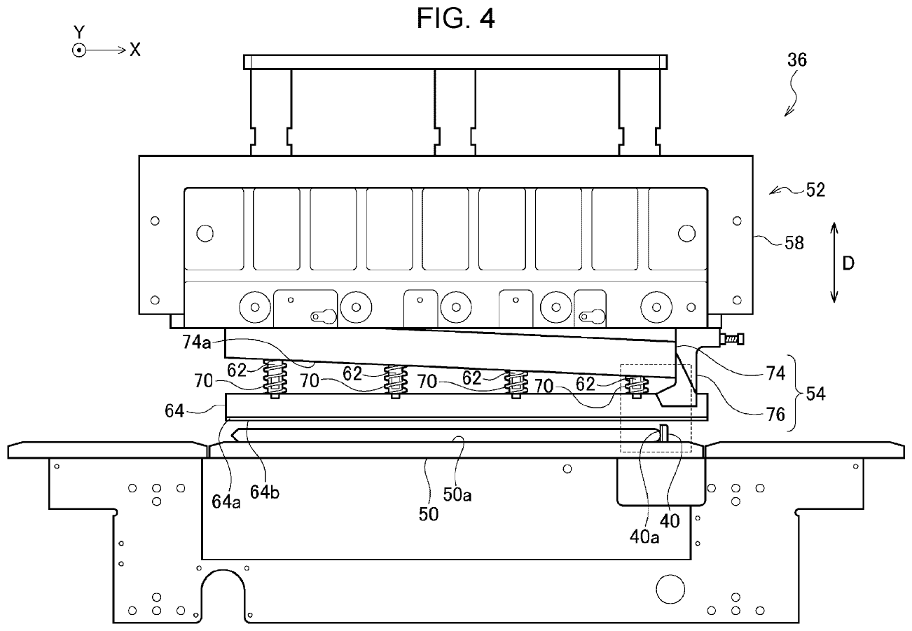

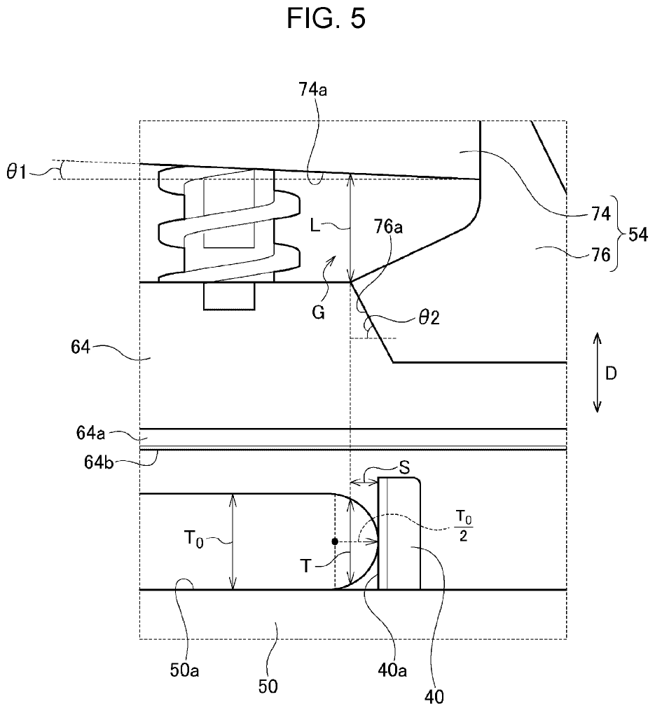

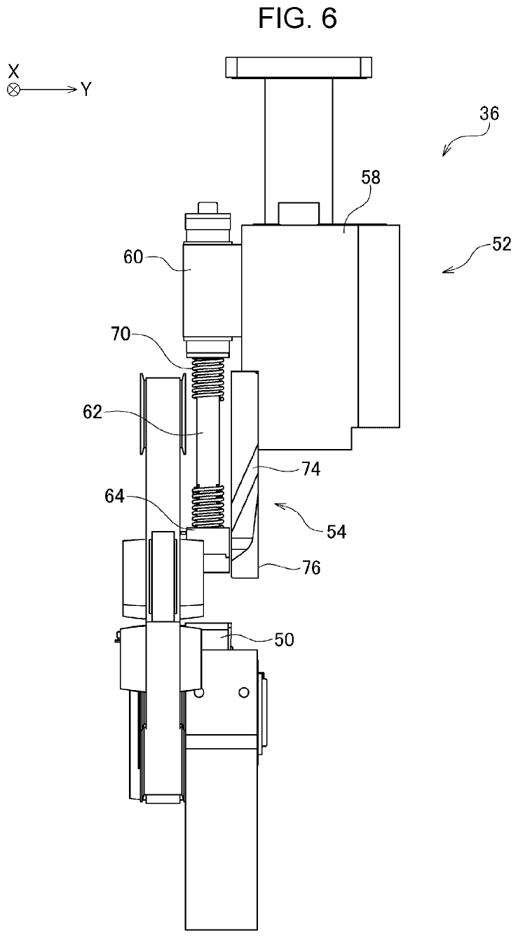

FIG. 2 is a side view of the top-bottom edge trimmer 22 as viewed from a direction orthogonal to a booklet conveying direction X (hereinafter referred to as “width direction Y”). FIG. 3 is a perspective view of the of the top-bottom edge trimmer 22 as viewed from an upstream side in the booklet conveying direction X (hereinafter referred to simply as “upstream side”). FIG. 4 is a side view of a trimming unit 36 on the right side as viewed from the upstream side, out of two trimming units 36 of the top-bottom edge trimmer 22, as viewed from the right side in the width direction Y. FIG. 5 is an enlarged view of a portion surrounded by dashed lines in FIG. 4. FIG. 6 is a frontal view of the trimming unit 36 on the right side as viewed from the upstream side, out of two trimming units 36 of the top-bottom edge trimmer 22, viewing from the upstream side of the booklet conveying direction.

The top-bottom edge trimmer 22 includes a conveying mechanism 34 for conveying booklets, and the two trimming units 36 for trimming the top and bottom of the booklets.

The conveying mechanism 34 includes two conveying units 38 that are disposed spaced apart in the width direction Y, and a stopper 40.

The two conveying units 38 each include a first conveying belt 44 that is provided on a lower side across a conveying path 42 (see FIG. 2), and a second conveying belt 46 provided on an upper side thereof. The first conveying belt 44 and the second conveying belt 46 are each run around a plurality of rollers 48 of which the rotation axes are oriented in the width direction Y. The booklets are conveyed over the conveying path 42 while pinched between the first conveying belt 44 and the second conveying belt 46, in a state in which the spines face the downstream side in the booklet conveying direction X (hereinafter referred to simply as “downstream side”) and the fore edges face the upstream side. In FIG. 2, for example, the booklets are conveyed over the conveying path 42 from the left side toward the right side.

The stopper 40 is driven by a driving unit 78, and is capable of advancing and retreating with respect to the conveying path 42. Booklets that are conveyed over the conveying path 42 strike an abutting face (face facing the upstream side) 40a of the stopper 40 that has advanced into the conveying path 42, with their spine, and come to a stop.

The two trimming units 36 are disposed spaced apart from each other in the width direction Y. Other than being symmetrical with respect to the width direction Y, the two trimming units 36 have the same structures.

The trimming units 36 each have a fixed blade (lower blade) 50, and a movable blade unit 52 that is capable of moving with respect to the fixed blade 50. The movable blade unit 52 includes a movable blade (upper blade) 54, two slide rails 56, a movable blade base 58, a block 60, a plurality of shafts 62, and a pressing unit 64. In the present embodiment, the movable blade unit 52 is configured to be movable in a direction (hereinafter referred to as “moving direction D”) that is perpendicular to a cutting edge 50a of the fixed blade 50 (e.g., upper face). Note that typically, the cutting edge 50a of the fixed blade 50 is horizontal, and accordingly the moving direction D is the vertical direction.

The two slide rails 56 both extend in the moving direction D, and are disposed spaced apart from each other in the booklet conveying direction X. The movable blade base 58 is driven by a driving mechanism that is not illustrated, and moves upward and downward along the two slide rails 56.

The block 60 is fixed to the movable blade base 58. The plurality of shafts 62 are inserted into the block 60 via slide bearings that are not illustrated, in the moving direction D. The pressing unit 64 is fixed to lower ends of the plurality of shafts 62.

The pressing unit 64 is a member that is slender in the booklet conveying direction X. A plurality of (four in the example illustrated) springs (elastic members) 70 are provided between the pressing unit 64 and the block 60. The pressing unit 64 is biased downward by the plurality of springs 70. Under this biasing force, the pressing unit 64 presses a top side or a bottom side of the booklet against the fixed blade 50 by a lower face (first pressing face) 64b of a lower end portion 64a.

The lower end portion 64a of the pressing unit 64 is formed of an elastic member, such as urethane material, for example. Thus, impact noise can be reduced.

The movable blade 54 is fixed to the movable blade base 58 on an outer side of the pressing unit 64, i.e., on a far side from the middle of the conveying path 42 in the width direction Y. The movable blade 54 descends while sliding against the fixed blade 50 disposed downward from the pressing unit 64, and trims the top side or the bottom side of the booklet.

In details, the movable blade 54 includes a main blade 74 and an accessory blade 76. The main blade 74 extends in the booklet conveying direction X. The accessory blade 76 is provided on a downstream end side of the main blade 74. The accessory blade 76 integrally moves with the main blade 74 in the moving direction D. The accessory blade 76 may be directly or indirectly attached to the main blade 74, or may be integrally formed with the main blade 74. A cutting edge 74a of the main blade 74 and a cutting edge 76a of the accessory blade 76 extend in the booklet conveying direction X, as viewed in the booklet conveying direction X and a direction orthogonal to the width direction Y. The cutting edge 76a of the accessory blade 76 is situated in the trimming face of the main blade 74. That is to say, as viewed in the moving direction D, the cutting edge 76a of the accessory blade 76 is situated on the same straight line as the cutting edge 74a of the main blade 74.

The main blade 74 and the accessory blade 76 are both inclined such that the cutting edges 74a and 76a are situated further on the lower side, the farther on the downstream side. An inclination angle of the cutting edge 74a of the main blade 74 with respect to the cutting edge 50a of the fixed blade 50 is θ1, and an inclination angle of the cutting edge 76a of the accessory blade 76 with respect to the cutting edge 50a of the fixed blade 50 is θ2.

The inclination angle θ2 of the cutting edge 76a of the accessory blade 76 is greater than the inclination angle θ1 of the cutting edge 74a of the main blade 74. That is to say, the cutting edge 76a of the accessory blade 76 is inclined greater with respect to the cutting edge 50a of the fixed blade 50 than the cutting edge 74a of the main blade 74. Accordingly, the angle of the cutting edge 76a of the accessory blade 76 as to the spine of the booklet is greater. In other words, the cutting edge 76a of the accessory blade 76 is an angle that is favorable for trimming the spine of the booklet, and consequently, shearing defects can be suppressed.

In one example, the inclination angle θ2 of the cutting edge 76a of the accessory blade 76 may be 60° or greater, and 80° or less.

When viewing the movable blade 54 from the fixed blade 50 side in the moving direction D, the cutting edge 76a of the accessory blade 76 is at least continuous with the cutting edge 74a of the main blade 74. In the example that is illustrated, the cutting edge 74a of the main blade 74 extends from farther on the upstream side than the accessory blade 76 to farther on the downstream side than the accessory blade 76, and when viewing the movable blade 54 from the fixed blade 50 side in the direction in which the movable blade 54 moves, the cutting edge 76a of the accessory blade 76 overlaps the cutting edge 74a of the main blade 74.

The cutting edge 76a of the accessory blade 76 is spaced apart from the cutting edge 74a of the main blade 74 in the moving direction D. That is to say, a gap G is provided between the cutting edge 74a of the main blade 74 and the cutting edge 76a of the accessory blade 76. The gap G here is a gap in the moving direction D between an upstream end of the cutting edge 76a of the accessory blade 76 and the cutting edge 74a of the main blade 74.

A distance L between the cutting edge 76a of the accessory blade 76 and the cutting edge 74a of the main blade 74 in the moving direction D (i.e., the size of the gap G) preferably is equal to or greater than a thickness T of a booklet in the booklet conveying direction where the upstream end of the cutting edge 76a of the accessory blade 76 passes through. In this case, when the main blade 74 comes into contact with the booklet, the booklet is freed from the accessory blade 76, i.e., the booklet is in a non-contact state with the accessory blade 76. Note that basically, the upstream end of the cutting edge 76a of the accessory blade 76 passes through the spine of the booklet, although this depends on the distance between the upstream end of the cutting edge 76a of the accessory blade 76 and the abutting face 40a of the stopper 40 in the booklet conveying direction X (hereinafter referred to as “slit amount”).

Now, in a case in which the booklet is a round back booklet, assuming that the shape of the spine is a true half circle as viewed from the width direction Y, the thickness T of a booklet through which the upstream end of the cutting edge 76a of the accessory blade 76 will pass in the booklet conveying direction position is represented by the Expression

$$T = 2 \times √ ( {T}_{\text{?}} S - {S}^{2} )$$

where T₀ represents the thickness of the booklet and S represents the slit amount.

Accordingly, the distance L may be

$$\{ 2 \times √ ( {T}_{\text{?}} S - {S}^{2} ) \}$$

or greater.

Note, however, that the actual shape of the spine of a round back booklet is not a true half circle, but rather is a half circle that is crushed vertically, somewhat like a semi-ellipse, as viewed in the width direction Y. The degree of crushing in thickness of the booklet in the booklet conveying direction position where the upstream end of the cutting edge 76a of the accessory blade 76 passes through is 15% at the greatest, although this depends on the slit amount S, i.e., the position of the upstream end of the cutting edge 76a of the accessory blade 76. Accordingly, the distance L may be

$$\{ 2 \times √ ( {T}_{\text{?}} S - {S}^{2} ) \times \text{?} \text{.85} \}$$

or greater.

In a case in which the greatest thickness T_{MAX} for a round back booklet that the top-bottom edge trimmer 22 will allow is 6 mm, the thickness T₀ of the booklet is this 6 mm, and the slit amount S is 1.5 mm, T is nearly equal to 5.2 mm. Accordingly, in a case in which the greatest thickness T_{MAX} for a round back booklet that is allowable is 6 mm, the distance L may be 5.2 mm or more. Also, taking into consideration the fact that the actual shape of the spine of a round back booklet is a half circle that is crushed as described above, the distance L may be 4.16 mm (5.2 mm×0.85) or greater.

Note that if the distance L is the greatest thickness T_{MAX} for a round back booklet that the top-bottom edge trimmer 22 will allow or greater, the distance L will inevitably be the thickness T of the spine of a booklet at the booklet conveying direction position that the upstream end of the cutting edge 76a of the accessory blade 76 passes through, or greater. Accordingly, the distance L may be the greatest thickness T_{MAX} for a round back booklet that the top-bottom edge trimmer 22 will allow or greater.

The slit amount S may be decided to be an appropriate value on the basis of experimentation. Note that the thinner the thickness T₀ of the booklet is, the less readily that shearing defects occur at the spine of the booklet, and accordingly the slit amount S may be decided on the basis of the greatest thickness T_{MAX} for a round back booklet that the top-bottom edge trimmer 22 will allow.

If the greatest thickness T_{MAX} for a round back booklet that is allowed changes, the slit amount S that is appropriate can change, although not always. Also, the slit amount S that is appropriate can change in accordance with the thickness and quality of sheets, as well. Accordingly, the slit amount S may be changeable. That is to say, the position of the stopper 40 in the booklet conveying direction X may be changeable.

The distance L may be changeable. Accordingly, when the greatest thickness T_{MAX} for a round back booklet that the top-bottom edge trimmer 22 will allow is set to a large setting, the distance L can be adjusted to a desirable magnitude. Note that the distance L may be changed by replacing the accessory blade 76 with a separate accessory blade 76 of different dimensions. Alternatively, the distance L may be change by changing the position of attaching the accessory blade 76 to the main blade 74.

The configuration of the top-bottom edge trimmer 22 has thus been described above. Note that while only cases of round back booklets have been described above, the top-bottom edge trimmer 22 according to the present embodiment can be used with square back booklets as well. While this is not always the case, the greatest thickness of the square back booklets that the top-bottom edge trimmer 22 allows is greater than the greatest thickness T_{MAX} for round back booklets that the top-bottom edge trimmer 22 allows. Note that in a case of square back booklets, shearing defects do not readily occur even when the distance L is not the thickness T or greater. Accordingly, the distance L may be the thickness T at the booklet conveying direction position where the upstream end of the cutting edge 76a of the accessory blade 76 passes through or greater for round back booklets, and the thickness T at the booklet conveying direction position where the upstream end of the cutting edge 76a of the accessory blade 76 passes through or less for square back booklets that are thicker than the round back booklets. In a case in which the top-bottom edge trimmer 22 allows a greater greatest thickness for square back booklets than for round back booklets, the distance L may be the thickness T for round back booklets of a greatest thickness T_{MAX} or greater, and the thickness T of square back booklets of the greatest thickness or less, or may be the greatest thickness T_{MAX} for round back booklets or greater and the greatest thickness for square back booklets or less.

Next, operations of the top-bottom edge trimmer 22 will be described.

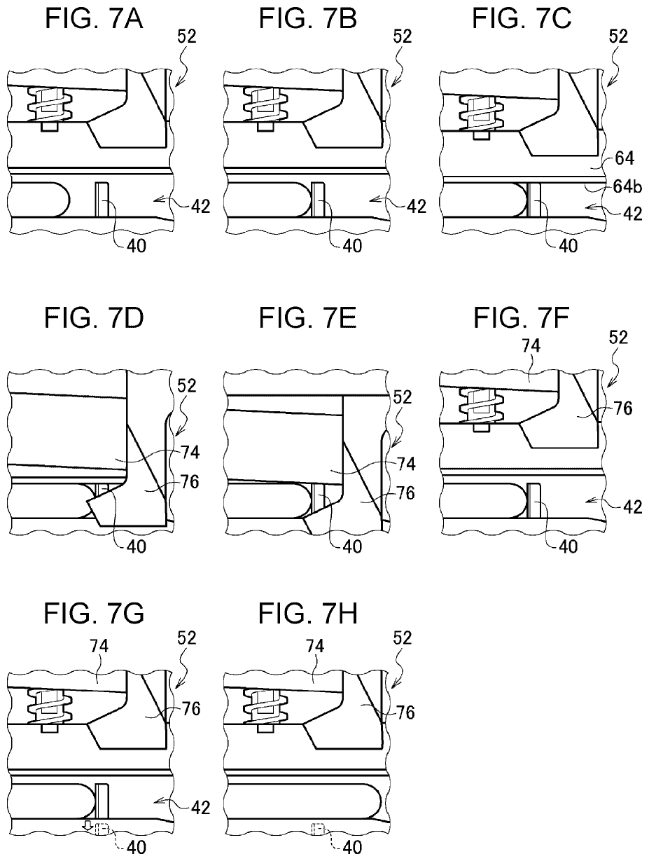

FIGS. 7A to 7H are diagrams for describing this way in which the top-bottom edge trimmer 22 performs trimming.

As illustrated in FIG. 7A, the stopper 40 advances into the conveying path 42, and a booklet is conveyed toward the downstream side (right side in FIGS. 7A to 7H), by the conveying mechanism 34 (not illustrated in FIG. 7A). Note that the conveying mechanism 34 is driven when arrival of a booklet to the top-bottom edge trimmer 22 is sensed by a suitable sensor that the fore edge trimmer 20 or the top-bottom edge trimmer 22 is provided with.

As illustrated in FIG. 7B, the spine of the booklet conveyed by the conveying mechanism 34 (not illustrated in FIG. 7B) strikes against the stopper 40 in the advanced position, and the booklet stops. A suitable sensor that is not illustrated senses that the booklet has abutted the stopper 40. In accordance with a detection signal thereof, the conveying mechanism 34 stops. The movable blade unit 52 starts descending.

As illustrated in FIG. 7C, when the movable blade unit 52 descends, the lower face 64b of the pressing unit 64 comes into contact with the top side or the bottom side of the booklet. When the movable blade unit 52 further descends, and the block 60 (not illustrated in FIG. 7C) further descends, the springs 70 (not illustrated in FIG. 7C) are clamped and are compressed between the block 60 and the pressing unit 64, thereby biasing the pressing unit 64 downward. Under this biasing force, the pressing unit 64 presses the top side or the bottom side of the booklet against the fixed blade 50 by the lower face 64b, and applies pressure.

As illustrated in FIG. 7D, when the movable blade unit 52 further descends, the accessory blade 76 starts cutting the spine portion of the booklet that is on the downstream side of the upstream end of the accessory blade 76. Thus, a cut is made in the spine portion of the booklet that is on the downstream side of the upstream end of the accessory blade 76.

As illustrated in FIG. 7E, when the movable blade unit 52 further descends, the cutting edge 74a of the main blade 74 slides against the fixed blade 50 and trims end edge portions of the top side and the bottom side of the booklet. Note that in the example that is illustrated, the distance L is the thickness T₀ of the booklet or greater, and accordingly, since the distance L is the thickness T (not illustrated in FIG. 7E) or greater, the booklet is freed from the accessory blade 76 when the main blade 74 is in contact with the booklet.

As illustrated in FIG. 7F, when the movable blade unit 52 ascends, the main blade 74 and the accessory blade 76 become spaced apart from the fixed blade 50, following which the pressing unit 64 is spaced apart from the booklet.

As illustrated in FIG. 7G, the stopper 40 retreats from the conveying path 42.

As illustrated in FIG. 7H, the booklet is conveyed toward the downstream side by the conveying mechanism 34 (not illustrated in FIG. 7H).

The operations of the top-bottom edge trimmer 22 have thus been described above. Next, advantages that the top-bottom edge trimmer 22 according to the embodiment yields will be described.

According to the present embodiment, a cut is made in the spine at the end edge portion of the booklet by the accessory blade 76 prior to the main blade 74, following which the end edge portion of the booklet is trimmed by the main blade 74. The distance L is set between the main blade 74 and the accessory blade 76. According to experiments performed by the inventor, shearing defects are suppressed in a case where there is the distance L.

According to the present embodiment, the magnitude of the distance L is the thickness T of the booklet at the booklet conveying direction position where the upstream end of the cutting edge 76a of the accessory blade 76 passes through, or greater. According to experiments performed by the inventor, shearing defects are suppressed even more in a case in which the magnitude of the distance L is the thickness T or greater.

The top-bottom edge trimmer 22 according to the embodiment has been described above. One skilled in the art will appreciate that this embodiment is exemplary and that various modifications can be made with combinations of the components, and also that such modifications also fall within the scope of the present disclosure.

### Modification 1

Although a case in which the pressing unit 64 presses the booklet against the fixed blade 50 has been described in the embodiment, the pressing unit 64 may press the booklet against a pressure-receiving face that is separate from the fixed blade 50 and is flush with the cutting edge 50a of the fixed blade 50.

### Modification 2

A case has been described in the embodiment in which the pressing unit 64 is biased downward by the springs 70, and the booklet is pressed against the fixed blade 50, but it is sufficient for the pressing unit 64 to be biased downward so as to press the booklet against the fixed blade 50, and may be biased downward by a weight, for example.

### Modification 3

A case has been described in the embodiment in which the movable blade 54 descends in a perpendicular direction with respect to the cutting edge 50a of the fixed blade 50, and trims the booklet. However, this is not limiting, and the movable blade 54 may be made to descend in a direction inclined with respect to the cutting edge 50a of the fixed blade 50 (i.e., a non-perpendicular direction with respect to the cutting edge 50a of the fixed blade 50). Specifically, for example, the movable blade 54 may be made to descend in a direction inclined as to the upstream side, i.e., in a direction that heads from the upstream side toward the downstream side while nearing the cutting edge 50a of the fixed blade 50.

### Modification 4

Unlike in the embodiment, the bookbinding system 10 does not need to have one or both of the square spine forming device 16 and the fore edge trimmer 20. Also, the bookbinding system 10 may have a sheet feeder that feeds out sheets one at a time from a sheet stack that has been stacked in page order in advance, instead of the collating devices 12. Also, instead of the collating devices 12, the bookbinding system 10 may have a printer that is capable of printing in page order, with sheets discharged from the printer being directly sent to the center stitching and folding device 14.

### Modification 5

A case has been described in the embodiment in which the center stitching and folding device 14 binds the accumulated sheet stacks and thereafter performs folding thereof in half at the bound portion. However, this is not limiting, and an arrangement may be made in which sheets are folded in two, one sheet at a time or a plurality of sheets at a time, following which the sheets are accumulated on a saddle until one set of sheet stacks that make up one booklet to be bound is complete, and then the one set of sheet stacks that is accumulated, may be bound at the fold. In this case, the shape of the spine of the round back booklet will be a different shape from that of the embodiment, specifically a semi-ellipse shape with a slightly pointed distal end of the spine. The thickness T of the booklet at the booklet conveying direction position where the upstream end of the cutting edge 76a of the accessory blade 76 passes through will conceivably be the same as that of the embodiment or smaller, and accordingly it is sufficient to decide the distance L in the same way as in the embodiment. Note that in the present modification, the bookbinding system 10 may be equipped with a folding device and center stitching device such as disclosed in Japanese Unexamined Patent Application Publication No. 2011-111243 previously filed by the present applicant, instead of the center stitching and folding device 14.

Optional combinations of the above-described embodiment and modifications are also useful as embodiments of the present disclosure. New embodiments created by combinations have the advantages of each of the embodiment and modifications that are combined. Also, those skilled in the art will appreciate that functions to be fulfilled by the components recited in the Claims are realized by the components described in the embodiment and the modifications, either individually or through cooperation.

Generalizing the above-described embodiment and Modifications yields the following Aspects.

### Aspect 1

A trimmer for trimming a booklet by a fixed blade and a movable blade, wherein
the movable blade includes a main blade that extends in a booklet conveying direction, and an accessory blade for making a cut in a spine of the booklet, the accessory blade being disposed at one end side of the main blade and integrally moving with the main blade, and
a cutting edge of the accessory blade is spaced apart from a cutting edge of the main blade, in a moving direction of the movable blade moving with respect to the fixed blade.

### Aspect 2

The trimmer according to Aspect 1, wherein a distance between the cutting edge of the accessory blade and the cutting edge of the main blade in the moving direction is equal to or greater than a thickness of a round back booklet at a position where an upstream end of the accessory blade passes through.

### Aspect 3

The trimmer according to Aspect 2, wherein the distance between the cutting edge of the accessory blade and the cutting edge of the main blade in the moving direction is equal to or smaller than a thickness of a square back booklet that is thicker than the round back booklet, at a position where the upstream end of the accessory blade passes through.

### Aspect 4

The trimmer according to any one of Aspects 1 to 3, wherein a distance between the cutting edge of the accessory blade and the cutting edge of the main blade in the moving direction is equal to or greater than a distance based on a greatest thickness of a round back booklet that the trimmer allows.

### Aspect 5

The trimmer according to Aspect 4, wherein the distance between the cutting edge of the accessory blade and the cutting edge of the main blade in the moving direction is equal to or smaller than a distance based on a greatest thickness of a square back booklet that the trimmer allows, and
the greatest thickness of the square back booklet that the trimmer allows is greater than the greatest thickness of the round back booklet that the trimmer allows.

### Aspect 6

The trimmer according to any one of Aspects 1 to 5, wherein a distance between the cutting edge of the accessory blade and the cutting edge of the main blade in the moving direction is equal to or greater than a greatest thickness of a round back booklet that the trimmer allows.

### Aspect 7

The trimmer according to Aspect 6, wherein the distance between the cutting edge of the accessory blade and the cutting edge of the main blade in the moving direction is equal to or smaller than a greatest thickness of a square back booklet that the trimmer allows, and
the greatest thickness of the square back booklet that the trimmer allows is greater than the greatest thickness of the round back booklet that the trimmer allows.

### Aspect 8

The trimmer according to any one of Aspects 1 to 7, wherein the fixed blade and the movable blade trim at least one of a top or a bottom of a booklet that is center stitched at a center stitching and folding device provided on an upstream side from the trimmer.

### Aspect 9

A trimming method, including:
starting descent toward a booklet by a movable blade that includes a main blade extending in a booklet conveying direction, and an accessory blade for making a cut in a spine of the booklet, the accessory blade being disposed at one end side of the main blade and integrally moving with the main blade;
starting to make a cut in a portion of the spine of the booklet by the accessory blade; and
trimming of the booklet by the main blade coming into contact with the booklet after an interval of time following the accessory blade starting the cutting, and further sliding against the fixed blade.

### Aspect 10

The trimming method according to Aspect 9, wherein,
in the trimming of the booklet, the main blade comes into contact with the booklet following the booklet being freed from the accessory blade.

### Aspect 11

The trimming method according to Aspect 9 or 10, wherein
the booklet is a center stitched booklet, and
the trimming is to trim at least one of a top and a bottom of the booklet.

What is claimed is:

1. A trimmer for trimming a booklet by a fixed blade and a movable blade, wherein
the movable blade includes a main blade that extends in a booklet conveying direction, and an accessory blade for making a cut in a spine of the booklet, the accessory blade being disposed at one end side of the main blade and integrally moving with the main blade, and
a cutting edge of the accessory blade is spaced apart from a cutting edge of the main blade, in a moving direction of the movable blade moving with respect to the fixed blade.

2. The trimmer according to claim 1, wherein a distance between the cutting edge of the accessory blade and the cutting edge of the main blade in the moving direction is equal to or greater than a thickness of a round back booklet at a position where an upstream end of the accessory blade passes through.

3. The trimmer according to claim 2, wherein the distance between the cutting edge of the accessory blade and the cutting edge of the main blade in the moving direction is equal to or smaller than a thickness of a square back booklet that is thicker than the round back booklet, at a position where the upstream end of the accessory blade passes through.

4. The trimmer according to claim 1, wherein a distance between the cutting edge of the accessory blade and the cutting edge of the main blade in the moving direction is equal to or greater than a distance based on a greatest thickness of a round back booklet that the trimmer allows.

5. The trimmer according to claim 4, wherein the distance between the cutting edge of the accessory blade and the cutting edge of the main blade in the moving direction is equal to or smaller than a distance based on a greatest thickness of a square back booklet that the trimmer allows, and
the greatest thickness of the square back booklet that the trimmer allows is greater than the greatest thickness of the round back booklet that the trimmer allows.

6. The trimmer according to claim 1, wherein a distance between the cutting edge of the accessory blade and the cutting edge of the main blade in the moving direction is equal to or greater than a greatest thickness of a round back booklet that the trimmer allows.

7. The trimmer according to claim 6, wherein the distance between the cutting edge of the accessory blade and the cutting edge of the main blade in the moving direction is equal to or smaller than a greatest thickness of a square back booklet that the trimmer allows, and
the greatest thickness of the square back booklet that the trimmer allows is greater than the greatest thickness of the round back booklet that the trimmer allows.

8. The trimmer according to claim 1, wherein the fixed blade and the movable blade trim at least one of a top or a bottom of a booklet that is center stitched at a center stitching and folding device provided on an upstream side from the trimmer.

9. A trimming method, comprising:
starting descent toward a booklet by a movable blade that includes a main blade extending in a booklet conveying direction, and an accessory blade for making a cut in a spine of the booklet, the accessory blade being disposed at one end side of the main blade and integrally moving with the main blade;
starting to make a cut in a portion of the spine of the booklet by the accessory blade; and
trimming of the booklet by the main blade coming into contact with the booklet after an interval of time following the accessory blade starting the cutting, and further sliding against the fixed blade.

10. The trimming method according to claim 9, wherein,
in the trimming of the booklet, the main blade comes into contact with the booklet following the booklet being freed from the accessory blade.

11. The trimming method according to claim 9, wherein
the booklet is a center stitched booklet, and
the trimming is to trim at least one of a top and a bottom of the booklet.
